(19) United States
(12) Patent Application Publication
(10) Pub. No.: US 2017/0324922 A1
(43) Pub. Date: Nov. 9, 2017

(54) SYSTEM AND METHOD FOR DISPLAYING MULTIPLE VIDEO STREAMS BASED ON A ZAPPING PATTERN

(71) Applicant: COMIGO LTD., Yarkona (IL)

(72) Inventor: Menahem LASSER, Kohav-Yair (IL)

(21) Appl. No.: 15/582,704

(22) Filed: Apr. 30, 2017

Related U.S. Application Data
(60) Provisional application No. 62/332,033, filed on May 5, 2016.

(51) Int. Cl. H04N 5/45; H04L 29/06; H04N 5/44; H04N 5/50

(52) U.S. Cl. CPC H04N 5/45; H04N 5/4403; H04L 65/60; H04N 5/50

(57) ABSTRACT

Devices and methods for automatically switching the content displayed on a display system from a single-stream mode displaying a single video stream to a multi-stream mode displaying more than one video stream.

### RELATED APPLICATION

The present application gains priority from U.S. Provisional Patent Application 62/332,033 filed on May 5, 2016 and entitled “Displaying Multiple Channels Based on Zapping Pattern”, which is incorporated herein by reference as if fully set forth herein.

### FIELD AND BACKGROUND OF THE INVENTION

The invention, in some embodiments, relates to displaying multiple video streams on a single display, and more particularly to methods and systems that enable automatically switching from display of a single video stream to display of multiple video streams based on a zapping pattern received from a user.

In recent years, many television (TV) sets and Set-Top Boxes (STBs) include features supporting the concurrent display of multiple TV channels, or video streams, on the screen. One common mode of concurrent display is “Picture-In-Picture” (PIP), in which a first channel or video stream is displayed on the majority of the screen or on the full screen, as in single-channel display mode, while a second channel or video stream is displayed as a smaller window. The smaller window may be “placed above”, or block part of, the display area of the first channel or video stream, or alternatively it may be partially transparent. Another common mode of concurrent display is “Split Screen”, in which the screen area is divided between two channels or video streams displayed side by side, not hiding each other. There also exist modes and/or products enabling the concurrent display of more than two channels or video streams, such as, for example, the 4-channel Quad PIP Split-Screen Video Matrix Switch in http://www.ambery.com/4hddvispqupi.html.

The various modes of concurrent display of multiple TV channels or video streams can be very useful for a viewer. For example, consider a viewer waiting for a live broadcast in a first channel from an important event that may start any minute, but may also be delayed by an unknown amount of time. The viewer may not desire to spend his time watching uninteresting broadcasting in the first channel and may instead switch to a second channel which may be of interest even when watching only for a short time period, such as a National Geographic channel. As the viewer does not want to miss the start of the event, every minute or two he switches to the first channel, and if broadcasting of the event has not yet begun—he immediately switches back to the second channel. This is very tedious and frustrating, and the user is likely to end up missing the start of the event, for example because of being fed up with the repeated zapping.

The above problem can be solved by using a two-stream viewing mode, for example a PIP mode. The viewer may choose the second channel for full screen display, and may activate PIP mode selecting the first channel to be displayed in the PIP window. In this arrangement, the viewer can watch the second channel, while being able to see what is going on in the first channel, without requiring any zapping. When the user sees that the event broadcast by the first channel is about to start, the viewer may switch to single-channel mode with the first channel as the only channel being displayed.

Another example for the usefulness of display of multiple channels or video streams on a single screen may occur when a viewer is watching a first channel that is his main interest, for example a news channel, but is also interested in the current score in a sporting event broadcast at the same time on a second channel. If the viewer is only interested in the score, and not in actually watching the sporting event, then the viewer will typically switch to the second channel broadcasting the sporting event every two or three minutes, and then switch back to the first channel displaying his main interest after several seconds. Again, the use of a two-channel viewing mode would greatly help such viewer.

However, many people find the use of, or the transition to, multi-stream modes complex and intimidating. This is especially true for users that are not tech-savvy, and for many elderly people. Such users typically only use their TV set in the classic single-stream mode, and do not take advantage of any advanced features available on their TV set, such as the multi-stream modes mentioned above.

There is therefore a need in the art for a method and device for automatically transitioning a user to a multi-stream mode, when such a stream is suitable, without requiring the user to take any explicit action to generate the multi-stream mode. Suitable conditions for use of a multi-stream mode may be determined by identification of a zapping pattern in zapping input provided by the user.

### SUMMARY OF THE INVENTION

Some embodiments of the invention relate to displaying multiple video streams on a single display, and more particularly to methods and systems that enable automatically switching from display of a single video stream to display of multiple video streams based on a zapping pattern received from a user.

According to an aspect of some embodiments of the invention, there is provided a method for displaying video streams on a display system, including:
a. displaying a first video stream on the display system in a single-stream mode;
b. receiving a sequence of zapping commands from a user;
c. identifying a zapping pattern in the sequence of zapping commands, the zapping pattern including at least one change from the first video stream to another video stream, and at least one return to the first video stream;
d. in response to the identifying the zapping pattern, automatically switching the display system from the single-stream mode to a multi-stream mode concurrently displaying the first video stream and at least one other video stream.

In some embodiments, the first video stream or the another video stream is a TV channel. In some embodiments, the first video stream or the another video stream is a local video stream. In some embodiments, the first video stream or the another video stream is a Video-On-Demand (VOD) video stream. In some embodiments, first video stream or the another video stream is an Internet video stream.

In some embodiments, the multi-stream mode is a two-stream mode. In some embodiments, the multi-stream mode is a side-by-side mode. In some embodiments, the multi-stream mode is a PIP mode.

In some embodiments, identifying a zapping pattern includes identifying a zapping pattern that includes one or more occurrences of a sub-pattern of the zapping pattern, the sub-pattern including zapping from the first video stream to a second video stream and then zapping back to the first video stream, and automatically switching includes automatically switching the display system from the single stream mode to a two-stream PIP mode.

In some embodiments, automatically switching to a two-stream PIP mode includes concurrently displaying the first stream in a PIP window of the two-stream PIP mode and the second stream in a main window of the two-stream PIP mode.

In some embodiments, automatically switching to a two-stream PIP mode includes concurrently displaying the second stream in a PIP window of the two-stream PIP mode and the first stream in a main window of the two-stream PIP mode.

In some embodiments, a condition associated with the zapping pattern relates to an identity of the first or the another video stream, or to a genre of the first video stream or the another video stream. In some embodiments, a condition associated with the zapping pattern relates to a genre of content played in the first video stream or in the another video stream at a time of identifying the zapping pattern. In some embodiments, a condition associated with the zapping pattern relates to at least one time difference between two successive zapping commands in the sequence of zapping commands.

In some embodiments, there is at least one occurrence of a video stream in a condition associated with the zapping pattern that is fully generic. In some embodiments, there is at least one occurrence of a video stream in a condition associated with the zapping pattern that is partially generic. In some embodiments, there is at least one occurrence of a video stream in a condition associated with the zapping pattern that is specific. In some embodiments, there is at least one occurrence of a video stream in a condition associated with the zapping pattern that is feature-specific.

In some embodiments, the method further includes:
e. subsequent to switching the display system to the multi-stream mode:
   i. switching the display system to the single stream mode;
   ii. receiving a second sequence of zapping commands from the user;
   iii. identifying a second zapping pattern in the second sequence of zapping commands, the second zapping pattern being different from the zapping pattern; and
   iv. in response to the identifying the second zapping pattern, automatically switching the display system from the single-stream mode to the multi-stream mode to concurrently display multiple video streams.

In some embodiments, identifying the zapping pattern includes ignoring at least one zapping command in the sequence of zapping commands within a subsequence of zapping commands associated with the zapping pattern.

In some embodiments, the method further includes, prior to identifying the zapping pattern, receiving additional input from a content provider, the additional input relating to at least some video streams accessed by the sequence of zapping commands, and wherein identifying the zapping pattern includes utilizing the additional input to determine whether the condition associated with the zapping pattern is met by a sub-sequence of the sequence of zapping commands.

According to another aspect of some embodiments of the invention, there is provided another method for displaying video streams on a display system, including:
a. displaying a first video stream on the display system in a single-stream mode;
b. receiving a sequence of zapping commands from a user;
c. identifying a zapping pattern in the sequence of zapping commands, the zapping pattern including at least one change to a second video stream containing video data of a predefined genre;
d. in response to the identifying the zapping pattern, automatically switching the display system from the single-stream mode to a multi-stream mode concurrently displaying at least the first video stream and the second video stream.

In some embodiments, the first video stream or the second video stream is a TV channel. In some embodiments, the first video stream or the second video stream is a local video stream. In some embodiments, the first video stream or the second video stream is a VOD video stream. In some embodiments, the first video stream or the second video stream is an Internet video stream.

In some embodiments, the multi-stream mode is a two-stream mode. In some embodiments, the multi-stream mode is a side-by-side mode. In some embodiments, the multi-stream mode is a PIP mode.

In some embodiments, automatically switching includes automatically switching the display system from the single stream mode to a two-stream PIP mode, concurrently displaying the second stream in a PIP window of the two-stream PIP mode and the first stream in a main window of the two-stream PIP mode.

In some embodiments, a condition associated with the zapping pattern relates to an identity of the first video stream or of the second video stream. In some embodiments, a condition associated with the zapping pattern relates to at least one time difference between two successive zapping commands in the sequence of zapping commands.

In some embodiments, there is at least one occurrence of a video stream in a condition associated with the zapping pattern that is fully generic. In some embodiments, there is at least one occurrence of a video stream in a condition associated with the zapping pattern that is partially generic. In some embodiments, there is at least one occurrence of a video stream in a condition associated with the zapping pattern that is specific. In some embodiments, there is at least one occurrence of a video stream in a condition associated with the zapping pattern that is feature-specific.

In some embodiments, the method further includes:
e. subsequent to switching the display system to the multi-stream mode:
   i. switching the display system to the single stream mode;
   ii. receiving a second sequence of zapping commands from the user;
   iii. identifying a second zapping pattern in the second sequence of zapping commands, the second zapping pattern being different from the zapping pattern; and
   iv. in response to the identifying the second zapping pattern, automatically switching the display system from the single-stream mode to the multi-stream mode to concurrently display multiple video streams.

In some embodiments, identifying the zapping pattern includes ignoring at least one zapping command in the sequence of zapping commands within a subsequence of zapping commands associated with the zapping pattern.

In some embodiments, the method further includes, prior to identifying the zapping pattern, receiving additional input from a content provider, the additional input relating to at least some video streams accessed by the sequence of zapping commands, and wherein identifying the zapping pattern includes utilizing the additional input to determine whether the second video stream contains video data of the predefined genre.

According to a further aspect of some embodiments of the invention, there is provided a device for displaying video streams on a display system associated therewith, the device including:
a. a processor associated with the display system or with a set top box feeding the display system; and
b. a non-transitory computer readable storage medium for instructions execution by the processor, the non-transitory computer readable storage medium having stored:
   i. instructions to display a first video stream on the display system in a single-stream mode;
   ii. instructions to receive a sequence of zapping commands from a user;
   iii. instructions to identify a zapping pattern in the sequence of zapping commands, the zapping pattern including at least one change from the first video stream to another video stream, and at least one return to the first video stream; and
   iv. instructions, to be carried out in response to identifying the zapping pattern, to automatically switch the display system from the single-stream mode to a multi-stream mode concurrently displaying the first video stream and at least one other video stream.

In some embodiments, the first video stream or the another video stream is a TV channel. In some embodiments, the first video stream or the another video stream is a local video stream. In some embodiments, the first video stream or the another video stream is a VOD video stream. In some embodiments, the first video stream or the another video stream is an Internet video stream

In some embodiments, the multi-stream mode is a two-stream mode. In some embodiments, the multi-stream mode is a side-by-side mode. In some embodiments, the multi-stream mode is a PIP mode.

In some embodiments, the instructions to identify a zapping pattern include instructions to identify a zapping pattern that includes one or more occurrences of a sub-pattern of the zapping pattern, the sub-pattern including zapping from the first video stream to a second video stream and then zapping back to the first video stream, and the instructions to automatically switch include instructions to automatically switch the display system from the single stream mode to a two-stream PIP mode.

In some embodiments, the instructions to automatically switch to the two-stream PIP mode include instructions to concurrently display the first stream in a PIP window of the two-stream PIP mode and the second stream in a main window of the two-stream PIP mode.

In some embodiments, the instructions to automatically switch to the two-stream PIP mode include instructions to concurrently display the second stream in a PIP window of the two-stream PIP mode and the first stream in a main window of the two-stream PIP mode.

In some embodiments, a condition associated with the zapping pattern relates to an identity of the first or the another video stream, or to a genre of the first video stream or the another video stream. In some embodiments, a condition associated with the zapping pattern relates to a genre of content played in the first video stream or in the another video stream at a time of identifying the zapping pattern. In some embodiments, a condition associated with the zapping pattern relates to at least one time difference between two successive zapping commands in the sequence of zapping commands.

In some embodiments, there is at least one occurrence of a video stream in a condition associated with the zapping pattern that is fully generic. In some embodiments, there is at least one occurrence of a video stream in a condition associated with the zapping pattern that is partially generic. In some embodiments, there is at least one occurrence of a video stream in a condition associated with the zapping pattern that is specific. In some embodiments, there is at least one occurrence of a video stream in a condition associated with the zapping pattern that is feature-specific.

In some embodiments, the non-transitory computer readable storage medium also has stored instructions, to be carried out while the display system is in the single-stream mode, including:
v. instructions to identify a second zapping pattern in a second sequence of zapping commands received from the user, the second zapping pattern being different from the zapping pattern; and
vi. instructions, to be carried out in response to the identifying the second zapping pattern, to automatically switch the display system from the single-stream mode to the multi-stream mode to concurrently display multiple video streams.

In some embodiments, the instructions to identify the zapping pattern include instructions to ignore at least one zapping command in the sequence of zapping commands occurring within a subsequence of zapping commands associated with the zapping pattern.

In some embodiments, the non-transitory computer readable storage medium also has stored instructions to be carried out prior to identifying the zapping pattern, to receive additional input from a content provider, the additional input relating to at least some video streams accessed by the sequence of zapping commands, wherein the instructions to identify the zapping pattern include instructions to utilize the additional input to determine whether the condition associated with the zapping pattern is met by a sub-sequence of the sequence of zapping commands.

According to yet another aspect of some embodiments of the invention, there is provided a device for displaying video streams on a display system associated therewith, the device including:
a. a processor associated with the display system or with a set top box feeding the display system; and
b. a non-transitory computer readable storage medium for instructions execution by the processor, the non-transitory computer readable storage medium having stored:
   i. instructions to display a first video stream on the display system in a single-stream mode;
   ii. instructions to receive a sequence of zapping commands from a user;
   iii. instructions to identify a zapping pattern in the sequence of zapping commands, the zapping pattern including at least one change to a second video stream containing video data of a predefined genre; and
   iv. instructions, to be carried out in response to the identifying the zapping pattern, to automatically switch the display system from the single-stream mode to a multi-stream mode concurrently displaying at least the first video stream and the second video stream.

In some embodiments, the first video stream or the second video stream is a TV channel. In some embodiments, the first video stream or the second video stream is a local video stream. In some embodiments, the first video stream or the second video stream is a VOD video stream. In some embodiments, the first video stream or the another video stream is an Internet video stream.

In some embodiments, the multi-stream mode is a two-stream mode. In some embodiments, the multi-stream mode is a side-by-side mode. In some embodiments, the multi-stream mode is a PIP mode.

In some embodiments, the instructions to automatically switch include instructions to automatically switch the display system from the single stream mode to a two-stream PIP mode, concurrently displaying the second stream in a PIP window of the two-stream PIP mode and the first stream in a main window of the two-stream PIP mode.

In some embodiments, a condition associated with the zapping pattern relates to an identity of the first video stream or of the second video stream. In some embodiments, a condition associated with the zapping pattern relates to at least one time difference between two successive zapping commands in the sequence of zapping commands.

In some embodiments, there is at least one occurrence of a video stream in a condition associated with the zapping pattern that is fully generic. In some embodiments, there is at least one occurrence of a video stream in a condition associated with the zapping pattern that is partially generic. In some embodiments, there is at least one occurrence of a video stream in a condition associated with the zapping pattern that is specific. In some embodiments, there is at least one occurrence of a video stream in a condition associated with the zapping pattern that is feature-specific.

In some embodiments, the non-transitory computer readable storage medium also has stored instructions, to be carried out while the display system is in the single-stream mode, including:
v. instructions to identify a second zapping pattern in a second sequence of zapping commands received from the user, the second zapping pattern being different from the zapping pattern; and
vi. instructions, to be carried out in response to the identifying the second zapping pattern, to automatically switch the display system from the single-stream mode to the multi-stream mode to concurrently display multiple video streams.

In some embodiments, the instructions to identify the zapping pattern include instructions to ignore at least one zapping command in the sequence of zapping commands occurring within a subsequence of zapping commands associated with the zapping pattern.

In some embodiments, the non-transitory computer readable storage medium also has stored instructions to be carried out prior to identifying the zapping pattern, to receive additional input from a content provider, the additional input relating to at least some video streams accessed by the sequence of zapping commands, wherein the instructions to identify the zapping pattern include instructions to utilize the additional input to determine whether the second video stream contains video data of the predefined genre.

Unless otherwise defined, all technical and scientific terms used herein have the same meaning as commonly understood by one of ordinary skill in the art to which the invention pertains. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 is a schematic block diagram of an embodiment of a device displaying multiple video streams on a display system associated therewith, according to an embodiment of the teachings herein; and

FIGS. 2A and 2B are flow charts of two embodiments of a method for displaying multiple video streams on a display screen, according to embodiments of the teachings herein, using the device of FIG. 1.

### DESCRIPTION OF SOME EMBODIMENTS OF THE INVENTION

The invention, in some embodiments, relates to displaying multiple video streams on a single display, and more particularly to methods and systems that enable automatically switching from display of a single video stream to display of multiple video streams based on a zapping pattern received from a user.

It is a goal of the present invention to monitor zapping commands provided by the user, identify zapping patterns that indicate scenarios in which a multi-stream mode would be beneficial, and to automatically switch the display from the single-stream mode to the multi-stream mode.

As described hereinabove, there are many approaches for displaying multiple video streams on a single display. However, the existing approaches require the user to initiate the multi-stream mode actively, which is difficult for many people, such as people who are not tech-savvy.

By contrast, as will be described in detail hereinbelow, the present invention provides methods and systems for identifying, in a series of zapping commands received from the user, a zapping pattern indicative of a situation in which a multi-stream mode would be beneficial. Upon identification of such a pattern, the system and method automatically switch the display to the multi-stream mode, without requiring the user to take any action to initiate the multi-stream mode.

For example, if it is found that the user is repeatedly switching between the same two television channels, it may be deduced that he is waiting for some program to start in one of the two channels while watching the other channel. It may also be deduced that the channel in which the user spends less time is the channel in which the program of interest will be shown. As a more specific example, the following sequence of events may be detected:
a. The user switched the television to channel Y.
b. After 8 seconds, the user switched to channel X.
c. After 1 minute, the user switched again to channel Y.
d. After 5 seconds, the user switched back to channel X.
e. After 45 seconds, the user switched again to channel Y.
f. After 6 seconds, the user switched back to channel X.

This pattern allows us to deduce that the user is waiting for a program to begin in channel Y, or that he wants to be periodically updated about what is shown in channel Y, while spending most of his time watching channel X. It would therefore serve the user's interests to switch the display into a two-stream mode showing both channels X and Y. In this specific case, a two-video stream PIP mode showing channel X in the full screen and channel Y in the PIP window would be particularly convenient for allowing the user to comfortably watch channel X while following what is being displayed in channel Y.

There may be multiple rules or conditions that, when identified, cause automatic switching to a multi-stream mode, each rule triggered by a different zapping pattern in the sequence of zapping commands received from the user and serving a different use case.

The rules applied for deciding when to automatically switch to a multi-stream mode may be configurable. For example, the following parameters may be adjustable:
a. A number of zapping commands required to trigger the rule. For example, if a zapping pattern corresponds to a repeated execution of a sub-pattern, then the number of occurrences of the sub-pattern required for triggering the rule may be adjustable.
b. A maximal length of time for watching a video stream that would still be considered a “short zapping” intended only to peek and see what is being displayed on a second video stream, such as to determine if a waited-on program had started.
c. A maximal length of time the user may spend watching a video-stream before the logic is reset to start looking for a new zapping pattern.
d. A maximal number of spurious switching operations that should be tolerated and ignored even though they do not conform to the corresponding zapping pattern.
e. Maximum time to stay in multi-stream mode (or no time limit).

Such configuration of the rules may be carried by the user, or, if the user is not tech-savvy or is intimidated by changing settings of the television, the configuration may be carried out by a technician or by a tech-savvy family member or caregiver of the user.

The rule for automatically switching to a multi-stream mode may be triggered not only when the user is watching a single video stream, but also when he is already watching multiple video streams. For example, the rule may have been triggered once and had switched the TV to display television channel X in the full screen and television channel Y in a PIP window. Subsequently, it is detected that the user is repeatedly zapping between channel X and channel Z. This may indicate loss of interest in the channel Y and an increase in interest in channel Z. Therefore, the rule may be triggered to keep the screen in multi-stream mode, but to replace channel Y by channel Z in the PIP window.

In some cases, the system and method may also include one or more rules that switch the display from a previously initiated multi-stream mode to a single-stream mode. For example, a user may be watching the display in at two-video stream PIP mode showing channel X full screen and channel Y in the PIP window, and it is detected that the user is successively zapping the full screen video stream between multiple television channels, one of which is channel Y. In such a situation, it may be deduced that the user is not making use of the PIP window and would be better served by switching to a single-stream mode.

Once the display was automatically switched to a multi-stream mode, it remain in that mode until one of the following occurs:
1. The user explicitly instructs the display to exit the multi-stream mode, for example using a remote controller.
2. A maximum time to stay in the multi-stream mode is reached. The maximum time may be defined during system configuration, as described above.
3. A rule that automatically switches to single-stream mode has been triggered.

The logic for implementing the system and method of the present invention may be within the TV set, for example, when it is a smart TV. In other embodiments, the logic may be within a Set-Top-Box (STB), and the multi-video stream image may be generated in the STB and fed into the TV set.

The disclosure herein relates to concurrently displaying two video streams. However, the system and method are equally applicable to concurrently displaying any number of video streams on the screen.

In the context of the present application, the terms “stream” and “video stream” are used interchangeably, and relate to any type of video data being streamed into a display system, including television channels, VOD streams, locally generated video streams, and Internet video streams.

In the context of the present application, the terms “Video-On-Demand stream” and “VOD stream” relate to video data stored by a service provider on a server or other storage location, and provided to the user upon the user explicitly requesting to watch the video data, for example by use of a remote controller.

In the context of the present application, the terms “locally generated video stream” and “local video stream” relate to video data generated in the physical location of the display system, or retrieved from a storage device located in the physical location of the display system. This may include video data generated by the user such as home videos, video files previously downloaded and stored in the user's home, and the like.

In the context of the present application, the term “Internet video stream” relates to video data that is accessible via the Internet, and is streamed to the display system upon access to the video data on the Internet, for example YouTube videos.

In the context of the present application, the terms “channel”, “TV channel” and “television channel” are used interchangeably, and relate to video data provided by a service provider, such as a cable company or a television broadcast company, according to a pre-defined schedule.

In the context of the present application, the terms “television screen” and “TV screen” relate to any screen on which a video stream can be displayed, regardless of whether or not it is dedicated for display of video streams. For example, a Personal Computer (PC) screen or a smartphone screen capable of displaying a video stream are considered TV screens.

In the context of the present application, the term “display system” relates to any system including a TV screen.

In the context of the present application, the terms “single-stream mode” or “one-stream mode” relate to a mode of a display system in which only a single video stream is being displayed on the TV screen. This does not rule out displaying graphics or messages in addition to the single video stream, but it does rule out concurrently displaying two or more video streams.

In the context of the present application, the term “multi-stream mode” relates to a mode of a display system in which two or more video streams are being displayed concurrently. The two or more video streams may be displayed side by side, in which case no video stream is hiding any portion of any other video stream. Alternatively, at least one of the two or more video streams may hide at least a portion of at least one other video stream on the TV screen.

In the context of the present application, the term “two-stream mode” relates to a specific case of the multi-stream mode, in which exactly two video streams are concurrently being displayed.

In the context of the present application, the term “side-by-side mode” relates to a specific case of the multi-stream mode, in which no video stream is hiding any portion of any other video stream. A side-by-side mode may be a two-stream mode.

In the context of the present application, the term “PIP mode” relates to a specific case of the multi-stream mode, in which one of the two or more video streams is a “main video stream” displayed in relatively large size, the other video streams are displayed in relatively small sizes, and one or more of the other video streams is overlaid on the main video stream, so that a portion of the main video stream is at least partially hidden by them. Any of the other video streams overlaid on the main video stream may be either fully opaque or partially transparent.

In the context of the present application, the term “two stream PIP mode” relates to a PIP mode that is also a two-stream mode.

In the context of the present application, the term “main window” relates to a window in a display system that is in PIP mode, which window displays a video stream that is the main video stream.

In the context of the present application, the term “PIP window” relates to a window in a display system that is in PIP mode, which window displays a video stream that is not the main video stream. A PIP window is typically overlaid over the main window.

In the context of the present application, the term “zapping command” relates to a user command for switching a TV screen or a portion thereof from displaying a first video stream to displaying a second video stream, different from the first.

In the context of the present application, the term “zapping pattern” relates to a sequence of time-ordered zapping commands that includes at least two zapping commands and that satisfies a pre-defined condition. Both the subsequence of zapping commands and the condition are then said to be “associated with” the zapping pattern. The condition may depend on identities of the video streams involved in the zapping commands and/or on time differences between the zapping commands. For example, a first zapping pattern may use the condition “switching from video stream X to video stream Y, then switching from video stream Y to video stream X” which depends on identities of channels. A second zapping pattern may use the condition “switching from any video stream to any video stream, then switching to any video stream in less than 5 seconds, then switching to any video stream in less than 3 seconds” which depends on time differences. A third zapping pattern may use the condition “switching from any video stream to video stream Y, then switching from video stream Y to video stream X after waiting for at least two minutes, then switching to video stream Y in less than 5 seconds, then switching to video stream X after waiting for at least one minute”, which depends on both identities of channels and time differences.

In the context of the present application, a video stream identified in a pre-defined condition associated with a zapping pattern is said to be “fully generic” if no limitation is imposed on the identity of the video stream in order to satisfy the condition. For example, “switch from any video stream” or “switch to any video stream” are satisfied by any video stream.

In the context of the present application, a video stream identified in a pre-defined condition associated with a zapping pattern is said to be “partially generic” if no significance is given to the specific identity of the video stream, except for the limitation that multiple occurrences of the same video stream name in a condition must be matched by the same specific video stream. For example, “switch from video stream X to any video stream, then switch back to video stream X” is satisfied when the user switched from Fox News to Sky News and then back to Fox News, but is not satisfied when the user switched from Fox News to Sky News and then from Sky News to CNN Headlines.

In the context of the present application, a video stream identified in a pre-defined condition associated with a zapping pattern is said to be “specific” if only a specific video stream satisfies the condition. For example, “switch to NBC” is satisfied only when switching to the NBC TV channel.

In the context of the present application, a video stream identified in a pre-defined condition associated with a zapping pattern is said to be “feature-specific” if only a video stream having a given feature satisfies the condition. The given feature may relate to an attribute of the video stream, such as the type of TV channel being a news channel or a sports channel. The given feature may relate to an attribute of the content currently streamed by the video stream, for example to comic content, regardless of the attributes of the TV channel or video stream including this content. For example, “switch from any video stream to a news channel, then switch to a video stream showing a comedy” is satisfied if the user switched to Fox News and then switched to ABC while a comedy was playing in ABC, but is not satisfied if the user switched to ESPN in the first step or if the ABC channel was broadcasting an election event when switched to in the second step.

In the context of the present application, the term “genre of a video stream” relates to a genre associated with the video stream, regardless of the type of video data currently being streamed. For example, the nickelodeon TV channel is a video stream of the children genre, even when commercials are being displayed or late at night when the content is unsuitable for children.

In the context of the present application, the terms “genre of a content” and “genre of content of a video stream” relate to a genre associated with video data currently being streamed by a video stream, regardless of the genre of the video stream. For example, when a movie channel is showing a comic movie, the genre of the content is comedy, and when the same movie channel is showing a horror film the genre of the content is drama or horror, even though both are displayed in the same TV channel.

In the context of the present application, a video stream is said to “contain” video data if it is currently playing the video data.

In the context of the present application, the term “or” is used as an “inclusive or”, such that the phrase “A or B” is satisfied by “only A”, “only B”, or “A and B”.

The principles, uses and implementations of the teachings herein may be better understood with reference to the accompanying description and figures. Upon perusal of the description and figures present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the examples. The invention can be implemented with other embodiments and can be practiced or carried out in various ways. It is also understood that the phraseology and terminology employed herein is for descriptive purpose and should not be regarded as limiting.

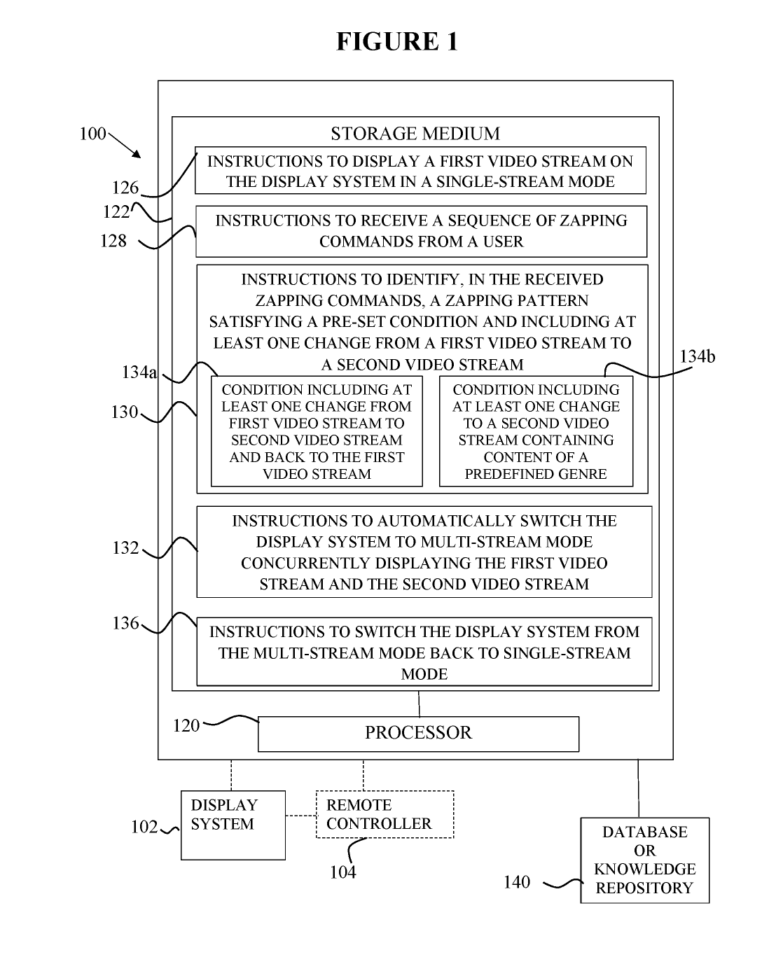

Reference is now made to FIG. 1, which is a schematic block diagram of an embodiment of a device displaying multiple video streams on a display system associated therewith, according to an embodiment of the teachings herein.

As seen in FIG. 1, a device 100 for displaying multiple video streams on a display system 102 associated therewith, includes a processor 120 and a storage medium 122, which is typically a non-transitory computer readable storage medium. The display system 102 is capable of displaying video streams in a single-stream mode as well as in a multi-stream mode.

In some embodiments, the device 100 forms part of the display system 102. This may occur, for example, when the display system is a smart TV, and the device 100 is included within the smart components of the smart TV. In other embodiments, the device 100 is external to, and associated with, a display system 102. For example, the device 100 may be a set-top-box associated with a television set as the display system 102.

The storage medium 122 includes instructions to be executed by the processor 120, in order to carry out various steps of the methods described herein, as described in further detail hereinbelow. Specifically, the storage medium includes at least the following instructions:

instructions 126 to display a first video stream on the display system 102 in a single-stream mode;

instructions 128 to receive a sequence of zapping commands from a user, for example via a user interface of the device 100 or of the display system 102, or via a remote controller 104 functionally associated with the device 100 and/or with the display system 102;

instructions 130 to identify, in the received sequence of zapping commands, a zapping pattern satisfying a pre-set condition or rule and including at least one change from the first video stream to a second video stream; and

instructions 132, to be carried out following identification of a zapping pattern using the instructions 130, to automatically switch the display system from the single-stream mode to a multi-stream mode concurrently displaying at least the first video stream and the second video stream.

In some embodiments, the instructions 130 are based on a condition 134a for identifying a zapping pattern including at least one change from the first video stream to a second video stream, and at least one return to the first video stream.

In some embodiments, the instructions 130 are based on a condition 134b for identifying a zapping pattern including at least one change to a second video stream containing video data of a predefined genre.

In some embodiments, the instructions 130 are based on multiple pre-set conditions or rules, such that the processor would identify the occurrence of a zapping pattern if any one or more of the rules or conditions were met.

In some embodiments, the instructions 130 include instructions for accessing a database or knowledge repository 140, which may be functionally associated with processor 120, for example via a communication system or a communication line. For example, such a database may be used to identify the genre of the video data of the second video stream, in order to ensure that the condition 134b is satisfied.

In some embodiments, the instructions 132 include instructions to automatically switch the display system to a two-stream mode. In some embodiments, the instructions 132 include instructions to automatically switch the display system to a side-by-side mode. In some embodiments, the instructions 132 include instructions to automatically switch the display system to a PIP mode.

In some embodiments, the storage medium further includes instructions 136 to switch the system from multi-stream mode back to single-stream mode. In some embodiments, the instructions 136 may specify that switching the system back to single-stream mode is triggered by receipt of an explicit signal from the user, for example via remote controller 104. In some embodiments, the instructions 136 may specify a maximal time duration for being in multi-stream mode, following which the display system should automatically be switched back to a single stream mode. In some embodiments, the instructions 136 may specify a rule or condition, such that when the condition is met, the display system is automatically switched back to a single stream mode. For example, the rule may specify that the display system should be switched back to single-stream mode when the content of the video stream in the PIP window changes, or when the content of the video stream in the main window changes. As another example, the rule may specify that the display system should be switched back to single-stream mode following three zapping commands being received from the user within a one minute period.

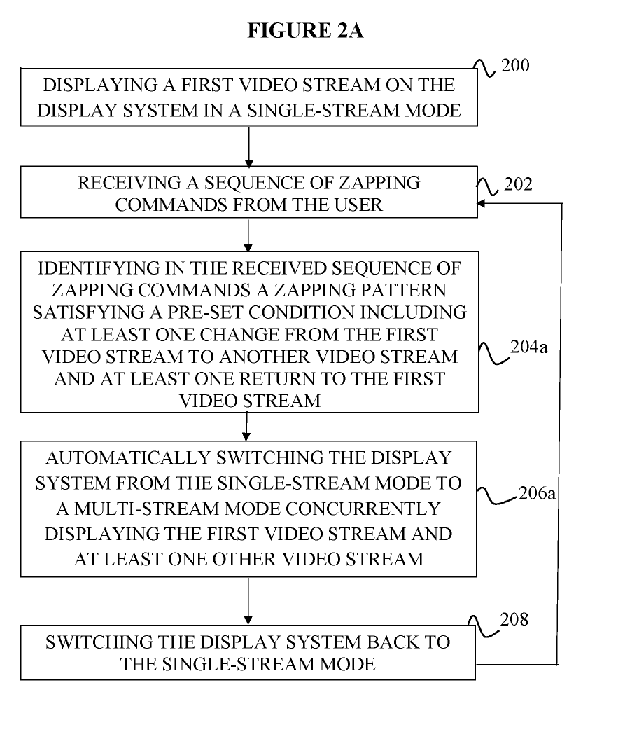

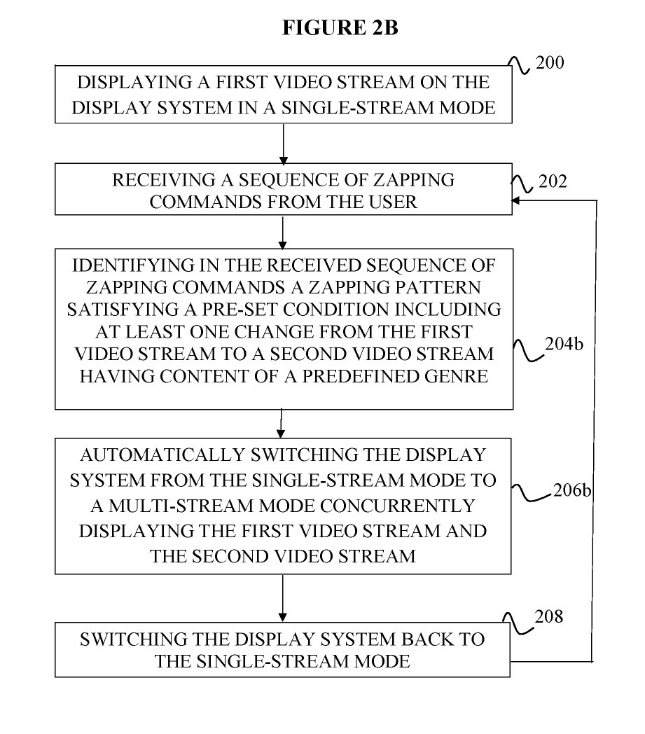

Reference is now additionally made to FIGS. 2A and 2B, which are flow charts of two embodiments of a method for displaying multiple video streams on a display screen, according to embodiments of the teachings herein, using the device of FIG. 1.

For the sake of example, the methods of FIGS. 2A and 2B will be described with respect to a two-stream PIP mode. However, the same methodology may be applied to a greater number of streams, or to a side-by-side mode.

As seen in FIGS. 2A and 2B, initially a first video stream is displayed on the display system 102 in a single-stream mode, at step 200. For example, this may be achieved by processor 120 carrying out instructions 126. The first video stream may be any suitable video stream, including a TV channel, a local video stream, a VOD video stream, or an Internet video stream.

At step 202, the processor 120 receives a sequence of zapping commands from the user. The zapping commands may be provided directly to a user interface of device 100 or of display system 102, or may be provided via remote controller 104 associated with the device and/or with the display system.

Turning specifically to FIG. 2A, at step 204a, the processor 120, carrying out instructions 130 and 134a, identifies in the received sequence of zapping commands a zapping pattern, satisfying a pre-set condition or rule including at least one change from the first video stream to another video stream, and at least one return to the first video stream. The another video stream may be any suitable video stream, including a TV channel, a local video stream, a VOD video stream, or an Internet video stream.

At step 206a, in response to identification of the zapping pattern, the processor 120, carrying out instructions 132, automatically switches the display system from the single-stream mode to a multi-stream mode concurrently displaying the first video stream and the another video stream. The multi-stream mode may be a two-stream mode, as disclosed in the examples herein, or may include more than two video streams. The multi-stream mode may be a PIP mode, as described in the examples hereinbelow. However, in some embodiments, the multi-stream mode may be a side-by-side mode, or any other type of suitable multi-stream mode.

For example, consider a condition requiring that the user zap from video stream A to video stream B and back to video stream A at least twice. John is watching a baseball game on ESPN, when it starts raining, and a rain delay is declared. John switches to watching a movie on VOD, but every few minutes he switches back to ESPN to check whether the baseball game he was watching has continued. John's zapping pattern would appear something like this:
1. watch ESPN for 1 hour;
2. switch to VOD for 3 minutes;
3. switch back to ESPN for 10 seconds;
4. switch again to VOD for 2 minutes;
5. switch back to ESPN.

At this point, the processor identifies that the condition has been met, since John has zapped from ESPN (video stream A) to VOD (video stream B) and back to ESPN twice. As such, the processor 120 would cause the ESPN channel and the VOD movie that John was watching to be displayed in a multi-screen mode.

As another example using the same condition, consider Hillary, who is watching her favorite movie “The American President” on The Movie Channel, while wanting to keep track of the real-time results of the presidential elections. Hillary watches the movie, but every few minutes switches to a news channel, such as CNN, to update herself with the current election results. Hillary's zapping pattern may look like this:
1. watch The Movie Channel for 15 minutes;
2. switch to CNN for 30 seconds;
3. Switch again to The Movie Channel for 5 minutes;
4. Return to CNN for 45 seconds;
5. Switch to Fox News for 30 seconds;
6. Switch back to The Movie Channel.

At this point, the processor identifies that the condition has been met, since Hillary has zapped from The Movie Channel (video stream A) to CNN (video stream B) and back to The Movie Channel, twice. As such, the processor 120 would cause The Movie Channel and CNN to be displayed in a multi-screen mode. In some embodiments, the processor may ignore the spurious zapping command to Fox News, since the pattern of zapping back and forth between The Movie Channel and CNN fulfills the rule, regardless of the additional, brief, zapping to Fox News.

In some embodiments, for example when the multi-screen mode is a two-stream PIP mode, the processor must also determine which of the video streams should be in the main window, and which should be in the PIP window.

In some embodiments, the condition or rule for identifying the zapping pattern may also specify the video stream that should be included in the main window. In other embodiments, the processor employs other logic, or additional pre-set rules, to determine which video stream should be in the main window. For example, the criterion for a video stream being in the PIP window may be that the user has zapped away from that video stream quickly, or that the duration spent by the user watching that video stream at each zapping portion, or cumulatively, is smaller than a predetermined threshold.

In John's example above, John spent a long time watching the baseball game on ESPN, but after the rain delay began and he started zapping, he only spent a few seconds at a time watching ESPN, and the majority of the time was spent watching the movie on VOD. As such, in this example, the first video stream that John was watching, namely ESPN, would be in the PIP window and the movie on VOD would be in the main window, so that John could focus on the VOD movie, and occasionally peek at the PIP window to see whether or not the game has resumed.

In Hillary's example, Hillary spent most of her time watching The Movie Channel, which was the first video stream she watched, and spent much shorter durations watching CNN (the second video stream) to follow the election results. As such, in this example, the first video stream that Hillary watched would be in the main window, and the second video stream, namely CNN, would be in the PIP window, allowing Hillary to track the election results while continuing to watch her favorite movie.

A condition requiring that the zapping pattern include at least one change from the first video stream to another video stream (the second video stream), and at least one return to the first video stream, as mentioned hereinabove, need not necessarily include ONLY the first and second video streams.

For instance, consider a condition requiring that the user zap from video stream A to at least one other video stream, then zap back to video stream A for a short time, and then zap away from video stream A. As an example, Sarah is watching her favorite drama series, “Law and Order: SVU” on the NBC channel. When a commercial break begins, Sarah zaps to a number of other channels, just to see what else is on, and then returns to NBC. Seeing that the commercials are not yet finished, Sarah continues looking at other channels. Sarah's zapping pattern may look like this:
1. Watch NBC for 15 minutes;
2. Switch to ABC for 2 minutes;
3. Switch to CBS for 1 minute;
4. Switch to HBO for 30 seconds;
5. Return to NBC for 5 seconds
6. Switch to CNN.

At this point, the processor identifies that the condition has been met, since Sarah has zapped from NBC (video stream A) to one other video stream (ABC), returned to NBC, and immediately switched to another video stream. As such, the processor 120 would cause NBC and at least one other channel from the group containing CNN, ABC, CBS, and HBO to be displayed in a multi-screen mode.

In the current example, the processor may display all the streams to which Sarah had zapped in a multi-stream side-by-side mode. However, in some embodiments, the processor may apply a multi-stream PIP mode, following a rule that defines which of the video streams included in the identified zapping pattern should be in the main window, and which should be in one or more PIP windows.

For example, the rule may specify that video stream A must be in a PIP window, and that the main window should display the most recently watched video stream, which was watched for more than 45 seconds. In such an embodiment, Sarah's screen would show NBC in a PIP window and CBS in the main window.

As another example, the rule may specify that the main window should include the video stream watched for the longest duration, and the PIP window should include video stream A. In such an embodiment, the PIP window would again show NBC, and the main window would show ABC, which was watched for the longest duration −2 minutes. As still another example, the rule may specify that the main window should include the video stream to which the user just switched (CNN), and the PIP window should include video stream A (NBC).

Turning now to FIG. 2B, at step 204b, the processor 120, carrying out instructions 130 and 134b, identifies in the received sequence of zapping commands a zapping pattern, satisfying a pre-set condition or rule including at least one change from the first video stream to a second video stream having content of a predefined genre. As discussed hereinabove, the second video stream may be any suitable video stream, including a TV channel, a local video stream, a VOD video stream, or an Internet video stream.

At step 206b in response to identification of the zapping pattern, the processor 120, carrying out instructions 132, automatically switches the display system from the single-stream mode to a multi-stream mode concurrently displaying the first video stream and the second video stream. The multi-stream mode may be a two-stream mode, as disclosed in the examples herein, or may include more than two video streams.

In some embodiments, the multi-stream mode may be a side-by-side mode.

In some embodiments, the multi-stream mode may be a PIP mode.

In some such embodiment, the second video stream may be displayed in the PIP window, particularly when the predefined genre is one in which viewers usually peek to see what is going on, but are often not interested in watching consecutively, such as sports games in which the viewer just wants to keep track of the score or reality shows in which the viewer is waiting to see who will be voted off the show.

Consider a condition whereby the processor enters multi-stream mode if the user zaps from any first video stream to a second video stream currently displaying a sports game. For example, Sam and his wife are watching a home video of their children when they were younger, preparing for their daughter's bridal shower. However, a football game of Sam's favorite team, “New England Patriots”, is taking place at the same time. As such, occasionally, such as every few minutes or between short home videos, Sam zaps to NESN to see whether the score has changed. Sam's zapping pattern may look like this:
1. Watch the home video for 3 minutes;
2. Switch to NESN for 10 seconds;
3. Switch back to the home video for 5 minutes;
4. Switch back to NESN.

Following the switch to NESN at step 2, the processor identifies that Sam is zapping from the home video to a channel broadcasting a sports game, and thus the condition is met. As such, the processor automatically switches the display on Sam's screen to a two-stream PIP mode, displaying NESN in the PIP window so that Sam can keep track of the Patriot's score, and displaying the home video in the main window.

Alternatively, the rule may specify that only after zapping twice to the same video stream currently displaying a sports game should we switch to the two-stream PIP mode, in which case the rule will be triggered only after step 4.

Relating now to step 204a of FIG. 2A as well as to step 204b of FIG. 2B, in some embodiments, the condition associated with the zapping pattern relates to the identity of the first video stream or of the second video stream. For example, the condition may be met, and the display may be switched into multi-stream mode, if the user zaps from any video stream to ESPN. As another example, the condition may be satisfied, and the display may be switched into multi-stream mode, if the user zaps from Fox News to any sports channel.

In some embodiments, the condition associated with the zapping pattern relates to at least one time difference between two successive zapping commands. For example, the condition may require that the user watches any first video stream, then zaps to any other video stream for a duration no longer than one minute, and then zaps back to the first video stream, in order to switch to multi-stream mode. As another example, the condition may require that the user watch a first video stream for at least 5 minutes prior to zapping to a second video stream, watch the second video stream for fewer than 15 seconds, and then zap back to the first video stream, following which the processor displays the first video stream in the main window and second video stream in the PIP window in two-stream PIP mode.

In some embodiments, the condition associated with the zapping pattern relates to a genre of the first or second video stream. For example, the condition may require that the user zap back and forth at least twice between a video stream of a movie channel and a video stream of a sports channel, following which the processor displays the video stream of the movie channel in the main window and video stream of the sports channel in the PIP window in two-stream PIP mode.

In some embodiments, the condition associated with the zapping pattern relates to a genre of content of the first or second video stream, regardless of the genres of the first and second video streams. For example, the condition may require that the user zap back and forth from a first video stream currently playing comedy content to a second video stream currently playing news programming, following which the processor displays the first and second video streams in a multi-stream mode. This condition may be met, for example, by a user watching “The Three Amigos” on VOD, and zapping to “World News” on ABC, even though VOD is not specifically a comedy video stream, and ABC is not specifically a news channel.

In some embodiments, the condition includes at least one occurrence of a video stream that is fully generic. In some embodiments, the condition includes at least one occurrence of a video stream that is partially generic. For example, the condition “switch from any first video stream X to any other video stream Y, and then back to the first video stream X” includes one occurrence of a video stream that is fully generic (“any other video stream Y”), and one occurrence of a video stream that is partially generic (“switch from any first video stream X” together with “back to the first video stream X”).

In some embodiments, the condition includes at least one occurrence of a video stream that is specific. For example, the condition “switch from any first video stream to ESPN” includes the occurrence of the specific video stream ESPN.

In some embodiments, the condition includes at least one occurrence of a video stream that is feature-specific. For example, the condition may relate to a video stream of a specific genre, or having content of a specific genre, as discussed hereinabove.

Returning to FIGS. 2A and 2B, in some embodiments, the processor 120 carries out instructions 136 and switches the display system back to single-stream mode, at step 208. The video stream displayed in the single stream mode may be any one of the video streams included in the multi-stream mode, or a completely different video stream not previously displayed.

As discussed hereinabove, in some embodiments, step 208 may be carried out in response to explicit instructions from the user, such as via remote controller 104, to terminate the multi-stream mode. In some embodiments, step 208 may be carried out automatically, for example when a maximum duration for being in multi-stream mode is reached, or when a predefined condition is met.

Following step 208, when the display system is again in single stream mode, the processor may return to step 202 and repeat the method again based on a second series of zapping commands, and a second zapping pattern. In some embodiments, the second zapping pattern identified by the processor may be different from the zapping pattern identified in the first iteration of the method.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method for displaying video streams on a display system, comprising:
a. displaying a first video stream on the display system in a single-stream mode;
b. receiving a sequence of zapping commands from a user;
c. identifying a zapping pattern in the sequence of zapping commands, said zapping pattern including at least one change from said first video stream to another video stream, and at least one return to said first video stream;
d. in response to said identifying said zapping pattern, automatically switching the display system from said single-stream mode to a multi-stream mode concurrently displaying said first video stream and at least one other video stream.

2. The method of claim 1, wherein said multi-stream mode is a side-by-side mode.

3. The method of claim 1, wherein said multi-stream mode is a PIP mode.

4. The method of claim 1, wherein:
said identifying a zapping pattern comprises identifying a zapping pattern that includes one or more occurrences of a sub-pattern of said zapping pattern, said sub-pattern including zapping from said first video stream to a second video stream and then zapping back to said first video stream; and
said automatically switching comprises automatically switching said display system from said single stream mode to a two-stream PIP mode.

5. The method of claim 4, wherein said automatically switching to a two-stream PIP mode includes concurrently displaying said first stream in a PIP window of said two-stream PIP mode and said second stream in a main window of said two-stream PIP mode.

6. The method of claim 4, wherein said automatically switching to a two-stream PIP mode includes concurrently displaying said second stream in a PIP window of said two-stream PIP mode and said first stream in a main window of said two-stream PIP mode.

7. The method of claim 1, wherein a condition associated with said zapping pattern relates to an identity of said first or said another video stream, or to a genre of said first video stream or said another video stream.

8. The method of claim 1, wherein a condition associated with said zapping pattern relates to a genre of content played in said first video stream or in said another video stream at a time of identifying the zapping pattern.

9. The method of claim 1, wherein a condition associated with said zapping pattern relates to at least one time difference between two successive zapping commands in said sequence of zapping commands.

10. The method of claim 1, wherein said identifying said zapping pattern includes ignoring at least one zapping command in said sequence of zapping commands within a subsequence of zapping commands associated with said zapping pattern.

11. A method for displaying video streams on a display system, comprising:
a. displaying a first video stream on the display system in a single-stream mode;
b. receiving a sequence of zapping commands from a user;
c. identifying a zapping pattern in the sequence of zapping commands, said zapping pattern including at least one change to a second video stream containing video data of a predefined genre;
d. in response to said identifying said zapping pattern, automatically switching the display system from said single-stream mode to a multi-stream mode concurrently displaying at least said first video stream and said second video stream.

12. The method of claim 11, wherein said multi-stream mode is a side-by-side mode.

13. The method of claim 11, wherein said multi-stream mode is a PIP mode.

14. The method of claim 11, wherein:
said automatically switching comprises automatically switching said display system from said single stream mode to a two-stream PIP mode, concurrently displaying said second stream in a PIP window of said two-stream PIP mode and said first stream in a main window of said two-stream PIP mode.

15. The method of claim 11, wherein a condition associated with said zapping pattern relates to an identity of said first video stream or of said second video stream.

16. The method of claim 11, wherein a condition associated with said zapping pattern relates to at least one time difference between two successive zapping commands in said sequence of zapping commands.

17. The method of claim 11, wherein said identifying said zapping pattern includes ignoring at least one zapping command in said sequence of zapping commands within a subsequence of zapping commands associated with said zapping pattern.

18. The method of claim 11, further comprising, prior to said identifying said zapping pattern, receiving additional input from a content provider, said additional input relating to at least some video streams accessed by said sequence of zapping commands, and wherein said identifying said zapping pattern includes utilizing said additional input to determine whether said second video stream contains said video data of said predefined genre.

19. A device for displaying video streams on a display system associated therewith, the device comprising:
a. a processor associated with the display system or with a set top box feeding the display system; and
b. a non-transitory computer readable storage medium for instructions execution by the processor, said non-transitory computer readable storage medium having stored:
i. instructions to display a first video stream on the display system in a single-stream mode;
ii. instructions to receive a sequence of zapping commands from a user;
iii. instructions to identify a zapping pattern in the sequence of zapping commands, said zapping pattern including at least one change from said first video stream to another video stream, and at least one return to said first video stream; and
iv. instructions, to be carried out in response to identifying said zapping pattern, to automatically switch the display system from said single-stream mode to a multi-stream mode concurrently displaying said first video stream and at least one other video stream.

20. A device for displaying video streams on a display system associated therewith, the device comprising:
a. a processor associated with the display system or with a set top box feeding the display system; and
b. a non-transitory computer readable storage medium for instructions execution by the processor, said non-transitory computer readable storage medium having stored:
i. instructions to display a first video stream on the display system in a single-stream mode;
ii. instructions to receive a sequence of zapping commands from a user;
iii. instructions to identify a zapping pattern in the sequence of zapping commands, said zapping pattern including at least one change to a second video stream containing video data of a predefined genre; and
iv. instructions, to be carried out in response to said identifying said zapping pattern, to automatically switch the display system from said single-stream mode to a multi-stream mode concurrently displaying at least said first video stream and said second video stream.
